(19) United States
(12) Patent Application Publication
(10) Pub. No.: US 2023/0289419 A1
(43) Pub. Date: Sep. 14, 2023

(54) SYSTEMS AND METHODS FOR USE IN NORMALIZING BIOMETRIC IMAGE SAMPLES

(71) Applicant: MASTERCARD INTERNATIONAL INCORPORATED, PURCHASE, NY (US)

(72) Inventor: David Grossman, Brooklyn, NY (US)

(21) Appl. No.: 18/119,662

(22) Filed: Mar. 9, 2023

Related U.S. Application Data
(60) Provisional application No. 63/319,146, filed on Mar. 11, 2022.

(51) Int. Cl. G06F 21/32; G06V 40/12; G06V 40/16

(52) U.S. Cl. CPC G06F 21/32; G06V 40/1365; G06V 40/172

(57) ABSTRACT

Systems and methods are provided for normalizing image samples. One example computer-implemented method includes receiving one or more reference images from a reference device and receiving one or more subject images from a subject device, where a target of the one or more reference images and the one or more subject images is consistent. The method also includes generating multiple metrics for the one or more reference images and the one or more subject images, where the multiple metrics include measurement and/or proportions associated with reference points included therein, and generating a transformation function based on the multiple metrics from the one or more reference images and the one or more subject images, where the transformation function describes normalization of the one or more subject images to approximate the one or more reference images. The method then includes storing the transformation function in a repository.

### CROSS-REFERENCE TO RELATED APPLICATION

This application claims the benefit of, and priority to, U.S. Provisional Application No. 63/319,146, filed Mar. 11, 2022. The entire disclosure of the above application is incorporated herein by reference.

### FIELD

The present disclosure is generally directed to systems and methods for use in normalizing image samples (e.g., biometric image samples, etc.), through transformation functions, for biometric matching (e.g., for biometrics obtained, extracted, determined, etc. from the image samples, etc.).

### BACKGROUND

This section provides background information related to the present disclosure which is not necessarily prior art.

In connection with identifying a user, the user may present a document to a relying party as evidence of his/her identity. The relying party, in turn, may inspect the document, and decide whether the identity of the user is proved, or not. It is known, more recently, for a user to present a biometric (or multiple biometrics) in connection with an interaction with a relying party, as evidence of the identity of the user, whereby the relying party verifies the biometric either directly or through a biometric processor to confirm the user's identity. Biometrics are also known to be used to permit access, for example, to devices such as smartphones and to services included therein, or to services apart from the devices (e.g., biometric pay services, etc.).

### DRAWINGS

The drawings described herein are for illustrative purposes only of selected embodiments and not all possible implementations, and are not intended to limit the scope of the present disclosure.

FIG. 1 is an example system of the present disclosure suitable for use in normalizing image samples, based on transformation functions associated with subject devices that may be used to capture, receive, etc., the image samples (and biometrics associated therewith);

FIG. 2 is a block diagram of an example computing device that may be used in the system of FIG. 1;

FIG. 3 is an example method, which may be implemented in connection with the system of FIG. 1, for use in normalization of image samples; and

FIGS. 4-5 are example methods, which may be implemented in connection with the system of FIG. 1, for use in assessing performance of a subject device in connection with capturing, processing, etc., biometric image samples.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Biometrics may be used as bases to verify identities of users, or more generally, to allow, enable, etc., access of data associated with users. In connection therewith, biometric samples, or images (where biometric samples may be associated with the images), are captured by capture devices, and then processed into biometrics (e.g., characteristics, features, or other aspects of the samples indicative of the users, etc.), which are compared to reference biometrics. Differences among the capture devices are known to result in differences in the captured samples or images, which may impact the biometrics derived therefrom. The differences in the biometrics, in turn, may impact the accuracy of matching the biometrics to the reference biometrics, whereby a proper user may be declined verification or other services, while, potentially, another user may be improperly granted the same, etc.

Uniquely, the systems and methods herein provide for normalizing biometric image samples captured by different capture devices. In particular, for example, image samples may be captured by a reference device (e.g., which may include a specific subject device, or not, or which may include a subject device of a pair of subject devices; etc.), and then also by one or more subject devices. The image samples may be compared, and a transformation function defined (based on differences therebetween) to convert the image samples captured by the subject device(s) so as to be consistent with the image samples captured by the reference device. The transformation function may then be deployed to the subject device(s) (or elsewhere (e.g., to other like subject devices, etc.)), whereby biometric image samples captured thereby are normalized by the transformation function. In this manner, differences and/or biases in the subject devices (e.g., between parties of subject devices, or between the subject device(s) and a reference device, etc.) are limited or eliminated, based on the normalization, whereby matching of biometrics extracted from the biometric image samples gains accuracy.

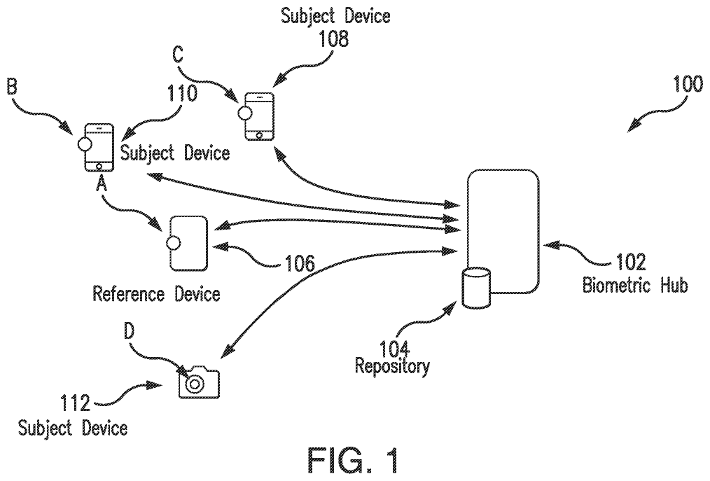

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, relationships between parties verifying and/or relying on biometrics (and users), biometric capture devices, data privacy requirements and/or regulations; etc.

The system 100 includes a biometric hub (or biometric host) 102, which is configured to coordinate between different devices as illustrated in FIG. 1, including, specifically, reference device 106 and subject devices 108, 110, and 112. In connection therewith, the biometric hub 102 includes a repository 104, which is configured to store data associated with normalization of biometric samples (between ones of the devices 106-112), as described in more detail below, captured by the subject devices 108-112, for example.

Each of the devices 106-112 is a device that includes a capture device (referenced A-D), which is configured, in this example, to capture a biometric sample from a user (not shown). The devices 106-112 may each be a computing device, such as, for example, a tablet, a smartphone, a camera, a laptop, etc., or other type of mobile device, or potentially, an immobile device, such as, for example, a point-of-sale terminal, an ATM, kiosks (e.g., a travel check-in kiosk, etc.), etc., or some combination thereof. The devices 106-112 may each be of the same type, brand, model, etc., or one or more may be of a different type, brand, model, etc. The capture devices A-D, likewise, may each be the same type, brand, model, etc., or one or more may be of a different type, brand, model, etc. The capture devices A-D will generally include an imaging sensor and a control system for the sensor (e.g., drivers and image processing software, etc.). In this example embodiment, the capture devices B-C are the same, and the capture devices A and D are different from capture devices B-C and also are different from each other. The subject devices 108-110 are, likewise, the same type, brand, and model in this example (but, may be different in other examples, while still including the same capture device).

In this example embodiment, the capture devices A-D are camera devices, which are configured to capture images. In particular, the capture devices A-D are configured to capture biometric image samples, which may include facial images, palm print images, or other modalities of biometrics (e.g., retina images, fingerprint images, etc.). In general, then, the capture devices A-D are configured for contactless image capture, whereby the capture devices A-D are not in contact with a user to capture the images, or biometric image samples, etc. It should be appreciated that other contact-based capture devices may be employed in other embodiments (e.g., fingerprint readers, etc.).

Additionally, in system 100, the biometric hub 102 is coupled, at least at some time, to the reference device 106 and the subject device 108, either by wired or wireless connections, to support communication therebetween, as described below. The biometric hub 102 may also be connected to the subject devices 110 and/or 112, to support communication therebetween, as described below. The connections between the biometric hub 102 and the devices 106-112 in the system 100 are illustrated by the arrowed lines.

In this example embodiment, the biometric hub 102 is configured to generate a transformation function for the subject device 108 (and, in particular, for the capture device C thereof). In connection therewith, the reference device 106 is configured to capture one or more reference images (via the capture device A), which may be (and/or may include) biometric image samples, or not. Also, the subject device 108 is configured to capture one or more subject images (via the capture device C). The reference images and the subject images are of the same target (e.g., object, setting, scene, person, etc.), and generally, of the same target set in a similar position and under similar conditions (e.g., light, etc.), whereby the images are expected to be the same. Otherwise, if not the same, generally, the images captured by the reference device 106 and the subject device 108 may be measurable different, whereby the difference may be factorable in the derived transformation function, or the images may include difference(s) expected to be encountered consistently as a field condition of the subject device 108. Often, the target will be a biometric of the type expected to be the target of biometric samples for the subject device 108 (e.g., a user face or palm, etc.). The same is applicable to the subject devices 110-112.

The reference device 106 is configured to pass the reference image(s) to the biometric hub 102, and the subject device 108 is likewise configured to pass the subject image(s) to the biometric hub 102.

In turn, upon receipt of the reference and subject images (or later), the biometric hub 102 is configured to identify various measurements (broadly, metrics) in, or of, the reference image(s) and the subject image(s), in the same manner, which would, for example, correspond to features within the images (e.g., measurements/proportions, resolution, contrast, dynamic range, sensitivity, noise, spectral sensitivity, etc.). Here, the image features may optionally be related to biometrics included in the images, or not. The biometric hub 102 is configured to then generate a transformation function, for the subject device 108, based on the measurements and/or image features (or metrics) (e.g., reference measurements/proportions and subject measurements/proportions, etc.), whereby applying the transformation function to the subject image(s), from the subject device 108, would result in the reference image(s). It should be appreciated that, for example, statistical analysis and comparisons of images that take into account multi-dimensional factors, such as, without limitation, image resolution, contrast, dynamic range, photosensitivity, noise, spectral sensitivity, etc., may be employed in generating the transformation function. Then, in this manner, the transformation function includes biases, corrections, or offsets (associated with a bias of the subject device 108), which may be used to “correct” the subject images to the reference images (as a baseline).

The biometric hub 102 is configured to store the transformation function (and potentially, the reference and subject images) in the repository 104. The biometric hub 102 is further configured to associate the transformation function with the subject device 108, either by type, brand, and/or model and/or by type, brand and/or model of the capture device C (included in the subject device 108). Additionally, the biometric hub 102 may be configured to associate the transformation function with a serial number, or unique identifier of the subject device 108 and/or the capture device C, whereby the transformation function is specific to that device.

While the transformation is generated for the subject device 108, relative to the reference device 106, it should be appreciated that the transformation function may be generated with respect to any pair of devices (e.g., subject device 112 and subject device 108, etc.), or other number of devices, whereby the transformation function is usable therebetween. In this manner, any of the subject devices 108-112 may be reference devices relative to one or more other devices, either shown in FIG. 1 or otherwise.

The biometric hub 102 may be further configured to verify the transformation function for the subject device 108. In particular, in one embodiment, the reference device 106 may be configured to capture (via the capture device A) one or more images of a different target, such as, for example, a different user, a different biometric sample of the user, or an alternate object, scene, setting, etc., and the subject device 108 is likewise configured to capture (via the capture device C) one or more images of the different target, with, again, generally the same settings and conditions. The subject images are passed to the biometric hub 102. And, the biometric hub 102 is configured to apply the transformation function, in reverse, to the reference image(s) from the reference device 106. The transformed reference image(s) are then compared to the image(s) from the subject device 108. The biometric hub 102 is configured to verify the transformation function (for the subject device 108) when the matching satisfies a defined threshold. It should be appreciated that the defined thresholds may be configured to meet acceptable margins of error based upon the use case. What's more, it should be appreciated that the images used above to generate the transformation function may be the same, or more likely, different than the images employed to verify the transformation function.

It should be appreciated that, in connection with verifying the transformation function, where the images include images of biometric or human features, the biometric hub 102 may generate, extract, etc. biometric templates from the subject images and the transformed reference images and compare the same (in lieu of comparing the images directly). Further, as part of verifying the transformation function, the biometric hub 102 may determine a limited set of capture conditions associated with the transformation function (i.e., boundaries of the effectiveness of the transformation function), where biometric match results are acceptable (e.g., as part of the defined threshold noted above, etc.).

Additionally, or alternatively, the biometric hub 102 may be configured to qualify the subject device 108 as sufficiently accurate, apart from the transformation function. In particular, a set of reference images of a user (or, more specifically, a part of a user (e.g., a face, a palm, etc.)) may be separated into reference set A and reference set B. The reference images may be captured by the reference device 106, for example, or otherwise designated as proper, correct images of the user, and transmitted to the biometric hub 102.

Then, the biometric hub 102 is configured to extract a biometric (or biometrics) from set A. For example, where the image is of the user's face, the biometric hub 102 may be configured, by techniques known to those skilled in the art, to generate a biometric template based on measurements and/or proportions relative to reference points in the face. Separately, the biometric hub 102 may be configured to transform the set B of reference images, based on a reverse application of the transformation function generated above for the subject device 108. The biometric hub 102 is configured to generate a biometric template for the transformed images. The biometric hub 102 is configured to then compare the biometric templates, and to qualify or disqualify the subject device 108 based on results of the matching. If, for example the biometric templates are more different than a defined threshold, the transformation function may be significantly altering the original images from the subject device 108, which may imply a lack of accuracy in the subject device 108 itself. In connection therewith, it should be appreciated that different matching techniques may be employed depending on the use case, and also, that the defined thresholds may be configured to meet acceptable margins of error based upon the use case. As part thereof, the defined threshold may be selected with reference to False Acceptance Rate or False Rejection Rate, as two example metrics. As such, in this manner, it should be noted that the subject device 108 may be qualified, or not, apart from the transformation function itself.

If the transformation function is verified and the subject device 108 is qualified, the biometric hub 102 is configured to designate the transformation function for use. That said, it should be appreciated that verification of the transformation function and/or qualification of the subject device 108 may be omitted in other embodiments.

It should be appreciated that the transformation function may be generated in an iterative manner, where configurations of the capture devices A-D are changed between iterations. In this manner, the different iterations may be employed to enhance the performance of the capture of the biometric image samples, and ultimately, the biometric matching based thereon.

Thereafter, in this example embodiment, the biometric hub 102 is configured to provision the transformation function to the subject device 108. In turn, the subject device 108 is configured to apply the transformation function to captured images, and more specifically, biometric image samples captured thereby, prior to identifying a biometric (or biometrics) in the image samples. The subject device 108 may then be configured to provide or transmit the transformed captured images (or the biometric thereof), as a request for authentication, to the biometric hub 102, or another device, which is configured to compare the same to the reference images (or the reference biometrics thereof) stored in the biometric hub 102 (or other device). When the biometrics match (e.g., based on the transformed image/biometric, etc.), the biometric hub 102 (or other device) is configured to output a result of the match as success or fail, either to the subject device 108, or another devices associated with the request for authentication.

In addition to the subject device 108, the biometric hub 102 may be configured to provision the transformation function to like subject devices (e.g., including devices of the same type, brand or model as the subject device 108 (and/or as the capture device C), etc.), which, in this example, includes the subject device 110. It should be appreciated that a transformation function may be generated, as described above, and provisioned for particular types of subject devices, particular brands of subject devices, or particular models of subject devices, or types, brands, or models of capture devices included therein, etc., or individually, for each subject device.

In this example, however, because the subject device 112 is different than the subject device 108 and includes a different capture device D, the biometric hub 102 is configured to generate and provision a transformation function specific to the subject device 112 (and, potentially, any one or more like devices).

As suggested above, it should be understood that the transformation functions, as generated and described herein, may be used at the subject devices 108-112, directly, whereby the subject device is configured to perform the transformation of images captured thereby (prior to extracting biometrics (and/or generating biometric templates) from the images/samples). Alternatively, the biometric hub 102 may be configured to provision the transformation functions to a central service, whereby the subject devices 108-112 may be configured to provide the captured biometric image samples to the central service (along with an identifier of the subject device), and the central service is configured to identify the appropriate transformation function from the identifier (e.g., model number, serial number, etc.), and to transform the captured images. The central service may be configured to return the transformed images to the subject devices 108-112, or to proceed to extract biometrics (and/or generate biometric templates), etc. The central service may be integrated into the biometric hub 102, in the example of FIG. 1, or otherwise in other embodiments.

Regardless, the transformation functions may then be used, in combination with the subject devices 108-112, to provide for biometric registration, verification, and/or identification, which may form part of payment services, digital identity services, enrollment services, access control, etc. In this manner, for example, it should be appreciated that the biometric hub 102 may be included, or integrated, in whole or in part, in a payment network, such as, for example, the MASTERCARD payment network, etc.

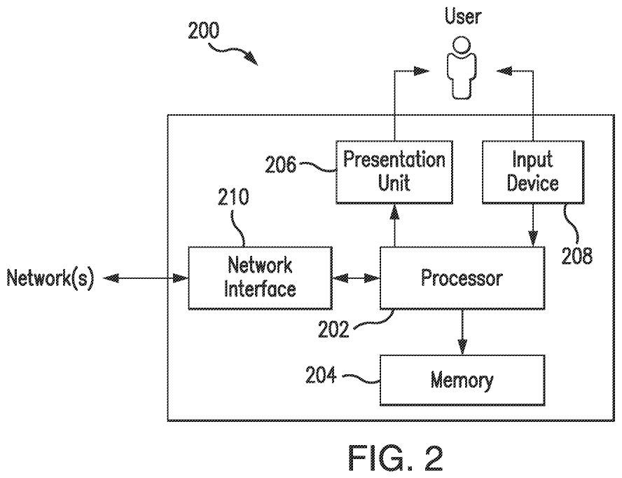

FIG. 2 illustrates an example computing device 200 that can be used in the system 100 of FIG. 1. The computing device 200 may include, for example, one or more servers, workstations, personal computers, laptops, tablets, smartphones, virtual devices, etc. In addition, the computing device 200 may include a single computing device, or it may include multiple computing devices located in close proximity or distributed over a geographic region, so long as the computing devices are specifically configured to function as described herein. In the example embodiment of FIG. 1, each of the biometric hub 102, the reference device 106 and the subject devices 108-112 may include or may be implemented in a computing device consistent with the computing device 200 (coupled to (and in communication with) the one or more networks of the system 100). However, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transformation functions, biometric image samples, identifiers, image features, measurements/proportions (or other metrics), biometric templates, and/or other types of data (and/or data structures) suitable for use as described herein.

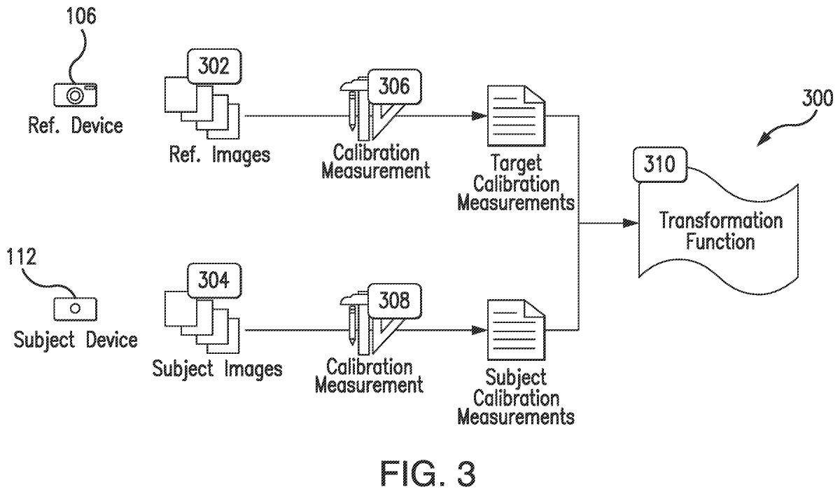

Furthermore, in various embodiments, computer-executable instructions may be stored in the memory 204 for execution by the processor 202 to cause the processor 202 to perform one or more of the functions described herein (e.g., one or more of the operations of the methods in FIGS. 3-5, etc.), such that the memory 204 is a physical, tangible, and non-transitory computer readable storage media. Such instructions often improve the efficiencies and/or performance of the processor 202 and/or other computer system components configured to perform one or more of the various operations herein, whereby upon performance of the same, the computing device 200 is transformed into a special-purpose computer system. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, visually or audibly, for example, to a user of the computing device 200, whereby the information may be displayed at (or otherwise emitted from) computing device 200, and in particular at presentation unit 206. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user of the computing device 200 (i.e., user inputs) such as, for example, biometric image samples (or other images), etc., as further described herein. The input device 208 may include a single input device or multiple input devices. The input device 208 is coupled to (and is in communication with) the processor 202 and may include, for example, one or more of a keyboard, a pointing device, a mouse, a camera, a biometric reader, a touch sensitive panel (e.g., a touch pad or a touch screen, etc.), another computing device, and/or an audio input device. In various example embodiments, a touch screen, such as that included in a tablet, a smartphone, or similar device, may behave as both the presentation unit 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a BLUETOOTH adapter, etc.), or other device capable of communicating to one or more different networks herein and/or with other devices described herein. Further, in some example embodiments, the computing device 200 may include the processor 202 and one or more network interfaces incorporated into or with the processor 202.

FIG. 3 illustrates an example method 300 for use in generating a transformation function, for example, for use in normalizing biometric samples. The example method 300 is described with reference to the biometric hub 102 and the other parts of the system 100, and also with reference to the computing device 200. However, the methods herein should not be understood to be limited to the system 100 or the computing device 200, as the methods may be implemented in other systems and/or computing devices. Likewise, the systems and the computing devices herein should not be understood to be limited to the example method 300.

At the outset, the biometric hub 102 receives, at 302, reference images from the reference device 106. The reference images are specific to a target and to specific conditions. The biometric hub 102 also receives, at 304, subject images from the subject device 112. Likewise, the subject images are specific to the same target and the same conditions as the reference images. It should be noted that the target may include a user (e.g., a face, a palm, a finger, etc., of the user; etc.), but may also include another target (e.g., an inanimate object, a color pattern, a feature pattern, etc.), which may aid in the generation of the transformation function. Also, the reference and/or subject images may be received via a wired or wireless connection, from either or both of the reference device 106 and the subject device 112.

At 306, the biometric hub 102 extracts measurements from the reference images (e.g., calibration metrics, etc.), whereby multiple reference points are identified and measurements and/or proportions therebetween (generally referred to as metrics) are determined. In the same way, at 308, the biometric hub 102 extracts measurements from the subject images. In various embodiments (at 306 and/or 308), the measurements may be extracted from one reference image and one subject image, or from multiple reference/subject images (e.g., under varying conditions, etc.). When measurements are extracted from multiple images, the measurements may be averaged or otherwise combined by the biometric hub 102.

The biometric hub 102 then generates, at 310, the transformation function for the subject device 112, and the capture device D therein. The transformation function is generated, in this example, to convert the measurements and/or proportions (e.g., metrics, etc.) of the subject images to the same measurements and/or proportions (e.g., metrics, etc.) for the reference images, as a form of correction, offset, and/or bias. In this manner, the transformation function describes normalization of the one or more subject images to approximate the one or more reference images (which may also be used in normalization of the one or more reference images to approximate the one or more subject images, (i.e., the transformation function may be bi-directional)). The biometric hub 102 then stores the transformation function in repository 104 (e.g., the memory 204 of the biometric hub 102 and/or memory 204 associated with the biometric hub 102, etc.) in association with an identifier of the subject device 112 (e.g., by type, brand, model, unique ID, etc.).

It should be appreciated that after method 300 is completed for a subject device, such as, for example, the subject device 112, the transformation function may be provisioned to the subject device 112 and/or to a central service associated with biometrics for the subject device 112.

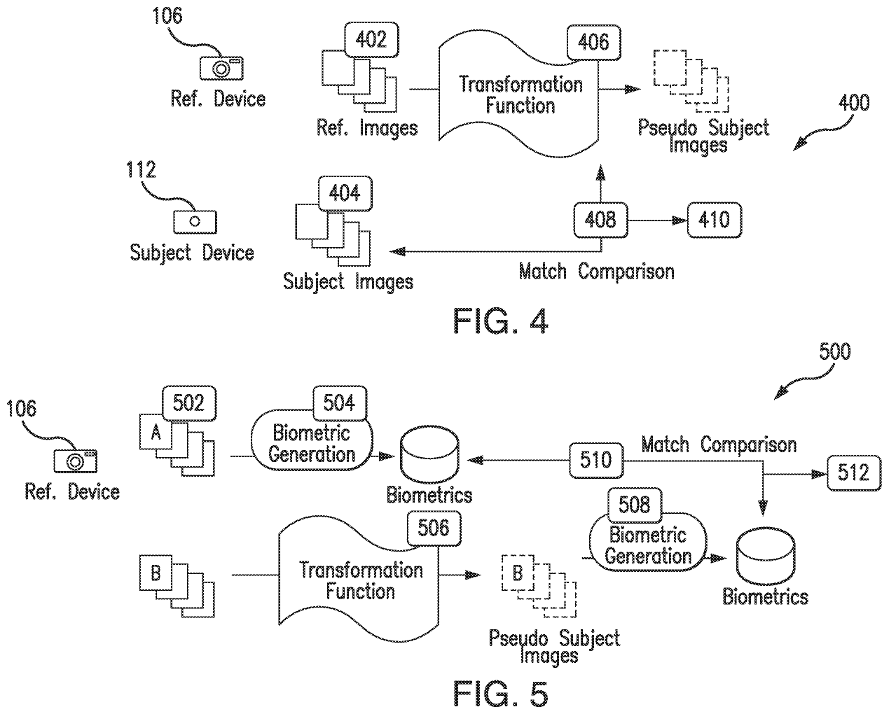

Additionally, before provisioning the transformation function, the biometric hub 102 may verify the transformation function consistent with the method 400 of FIG. 4 and/or qualify the subject device 112 consistent with the method 500 of FIG. 5. The example methods in FIGS. 4-5 are described with reference to the biometric hub 102 and the other parts of the system 100, and also with reference to the computing device 200. However, the methods should not be understood to be limited to the system 100 or the computing device 200, as the methods may be implemented in other systems and/or computing devices. Likewise, the systems and the computing devices herein should not be understood to be limited to the example methods 400 and 500.

With reference to FIG. 4, at 402, the biometric hub 102 receives reference images from the reference device 106. As above, the reference device 106 is the standard device, or correct device, in this example, which the subject device 112 is expected to emulate. Likewise, the biometric hub 102 receives, at 404, subject images from the subject device 112. As above, the reference and subject images may include a user as the target, or a different target, but generally include the same conditions. That is, the reference images and the subject images are expected to be the same.

Next, the biometric hub 102 transforms, at 406, the reference images, via a reverse application of the transformation function generated in method 300 for the subject device 112. For example, where the transformation function is added to a subject image, the transformation function is subtracted from the reference image and vice-versa. The transformed image, then, is expected to be consistent with the subject image. At 408, the biometric hub 102 compares the pseudo subject images (i.e., the transformed reference images) to the subject images to determine if there is a match (as generally described above in the system 100). When matching, the biometric hub 102 verifies, at 410, the transformation function for further use in connection with the subject device 112 (and, potentially, like subject devices and/or devices with like capture devices).

In connection therewith, the transformation function may be used by either the subject device 112, the reference devices 102, or the biometric hub 102, for example, to normalize an image captured by the subject device 112. In particular, the subject device 112 (or capture device D) captures a biometric image sample of a user associated with the subject device 112, or otherwise exposed to the subject device 112 (e.g., a customer at a merchant, etc.). The subject device 112, in this example, transforms the captured biometric image sample, based on a transformation function specific to the subject device 112. The subject device 112 then extracts a biometric template from the transformed biometric image sample. The biometric template may include a portion of the transformed biometric image sample, which includes an image of one or more physical features of the user (e.g., fingerprint, palm, face, retina, etc.).

Thereafter, for purposes of authentication, the subject device 112 transmits the extracted biometric template to the biometric hub 102 (or another devices) for matching to a reference biometric stored at the biometric hub 102. After comparison, the biometric hub 102, if there is a match, may report or return the authentication to the subject device 112, or another associated device, etc.

It should be appreciated that while the transformation and extraction is performed by the subject device 112 above, the biometric hub 102 may receive the captured image(s) from the subject device 112, and then the biometric hub 102 may transform the captured biometric image sample(s), based on a transformation function specific to the subject device 112 and extract a biometric template from the transformed biometric image sample(s), for comparison to a reference included therein.

In the above, in connection with verification of the transformation function, rather than later authentication of the user, the biometric hub 102 matches the extracted biometric template to the biometric reference (which is known to be associated with the subject of the image from the subject device 112) and verifies the transformation function (for the subject device 112) in response to the matching satisfying a defined threshold. The defined threshold may be a percentage of match, or a deviation, etc. Once verified, the biometric hub 102 may report the verification to the subject device 112 and/or a party associated therewith (e.g., a merchant, etc.).

Turning to method 500 of FIG. 5, the biometric hub 102 generally qualifies the subject device 112, or not. At 502, the biometric hub 102 accesses reference images from reference device 106 and separates the reference images into two sets: set A and set B. In this example, the reference images are biometric or human image samples, and each is directed to the same target user (e.g., a face image, a palm image, etc., of the user; etc.). At 504, the biometric hub 102 generates biometrics (or biometric templates) from the image samples in set A, by extracting specific biometric features (e.g., measurements, proportions, etc.) from the samples/images. The biometric is expressed, in this example, as a biometric template. It should be appreciated that various techniques, understood by those skilled in the art, may be employed at step 504 to extract biometrics from the image samples (and generate the biometric templates).

At 506, the biometric hub 102 transforms the biometric image samples in set B, as shown, via a reverse application of the transformation function generated in method 300 for the subject device 112 (to produce pseudo subject images). The biometric hub 102 then generates, at 508, biometrics (or biometric templates) from the transformed biometric samples (i.e., from the pseudo subject images) in set B, in the same manner as above, by extracting specific biometric features (e.g., measurements, proportions, etc.) from the image samples (and generating the biometric templates).

The biometric hub 102 then compares, at 510, the biometric templates generated above. If the biometric templates are within a defined threshold, the biometric hub 102 qualifies, at 512, the subject device 112, for use in further biometric services associated with the biometric hub 102, or other associated parties, etc. If not, the biometric hub 102 disqualifies the subject device 112, at 512, for use in further biometric services associated with the biometric hub 102, or other associated parties, etc.

When verified and/or qualified by methods 400 and 500 (or not), the transformation function of method 300 is then deployed by the biometric hub 102 to the subject device 112 and/or like devices, directly at the device(s) or at a central service associated with biometrics for the device(s). In connection therewith, biometric image samples captured by the subject devices are corrected, or normalized, by transforming the captured image samples according to the transformation function (e.g., in advance of comparing, analyzing, evaluating, etc. biometric templates generated from the image samples; etc.).

In view of the above, the systems and methods herein provide for normalization of biometric image samples across different subject devices, relative to a “reference device,” through use of a transformation function. In this manner, the accuracy of the biometric image samples (and biometric templates generated therefrom) between two or more devices is improved with reference to one of the devices (e.g., the reference device, etc.), whereby more accurate and reliable biometric authentication and/or matching may be achieved. This provides enhanced confidence in the matching/authentication based on the biometrics. In other words, images of biometric samples, or otherwise, are compensated for biases of capture devices to improve fidelity of subsequent biometric matching that is otherwise hampered by capture device biases.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the recited steps and/or operations of the claims, including one or more of: (a) receiving, at a hub computing device, one or more reference images from a reference device; (b) receiving, by the hub computing device, one or more subject images from a subject device, wherein a target of the one or more reference images and the one or more subject images is consistent; (c) generating, by the hub computing device, multiple metrics for the one or more reference images and the one or more subject images, the multiple metrics including measurements and/or proportions associated with reference points included in the one or more reference images and the one or more subject images; (d) generating, by the hub computing device, a transformation function based on the multiple metrics from the one or more reference images and the one or more subject images, wherein the transformation function includes normalization of the one or more subject images to approximate the one or more reference images; (e) storing, by the hub computing device, the transformation function in a repository; (f) accessing second reference images from the reference device and second subject images from the subject device, wherein a second target of the second reference images and the second subject images is consistent; (g) transforming the second reference images; (h) comparing the transformed reference images to the transformed second subject images; (i) verifying the transformation function in response to the comparison satisfying a defined threshold; (j) accessing a first set of image(s) and a second set of image(s), each of the first and second set of image(s) including a biometric sample of one user; (k) extracting, by the hub computing device, a first biometric from the first set of image(s); (1) transforming, by the hub computing device, the second set of image(s), based on the transformation function; (m) extracting, by the hub computing device, a second biometric from the transformed second set of image(s); (n) comparing the first and second biometrics; (o) qualifying the subject device, in response to the comparison satisfying a defined threshold; (p) capturing, by a capture device of a subject device, a biometric image sample of a user; (q) transforming, by the subject device, the captured biometric image sample, based on a transformation function specific to the subject device; (r) extracting, by the subject device, a biometric template from the transformed biometric image sample; (s) transmitting, by the subject device, the extracted biometric template to a biometric hub, for matching with a reference biometric; (t) matching, by the biometric hub, the extracted biometric template to the biometric reference; and/or (u) verifying, by the biometric hub, the transformation function for the subject device in response to the matching satisfying a defined threshold.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for normalizing biometric samples, the method comprising:
receiving, at a hub computing device, one or more reference images from a reference device;
receiving, by the hub computing device, one or more subject images from a subject device, wherein a target of the one or more reference images and the one or more subject images is consistent;
generating, by the hub computing device, multiple metrics for the one or more reference images and the one or more subject images, the multiple metrics including measurements and/or proportions associated with reference points included in the one or more reference images and the one or more subject images;
generating, by the hub computing device, a transformation function based on the multiple metrics from the one or more reference images and the one or more subject images, wherein the transformation function includes normalization of the one or more subject images to approximate the one or more reference images; and
storing, by the hub computing device, the transformation function in a repository.

2. The computer-implemented method of claim 1, wherein the target of the one or more reference images and the one or more subject images includes a physical feature of a person.

3. The computer-implemented method of claim 2, wherein the physical feature includes a face or a palm of the person.

4. The computer-implemented method of claim 1, further comprising:
accessing second reference images from the reference device and second subject images from the subject device, wherein a second target of the second reference images and the second subject images is consistent;
transforming the second reference images;
comparing the transformed reference images to the transformed second subject images; and
verifying the transformation function in response to the comparison satisfying a defined threshold.

5. The computer-implemented method of claim 1, further comprising:
accessing a first set of image(s) and a second set of image(s), each of the first and second set of image(s) including a biometric sample of one user;
extracting, by the hub computing device, a first biometric from the first set of image(s);
transforming, by the hub computing device, the second set of image(s), based on the transformation function;
extracting, by the hub computing device, a second biometric from the transformed second set of image(s);
comparing the first and second biometrics; and
qualifying the subject device, in response to the comparison satisfying a defined threshold.

6. The computer-implemented method of claim 1, further comprising provisioning the transformation function to the subject device.

7. A computer-implemented method for normalizing biometric samples, the method comprising:
capturing, by a capture device of a subject device, a biometric image sample of a user;
transforming, by the subject device, the captured biometric image sample, based on a transformation function specific to the subject device;
extracting, by the subject device, a biometric template from the transformed biometric image sample; and
transmitting, by the subject device, the extracted biometric template to a biometric hub, for matching with a reference biometric.

8. The method of claim 7, wherein the biometric image sample of the user includes an image of a face of the user.

9. The method of claim 7, wherein the biometric image sample of the user includes an image of a palm of the user.

10. The method of claim 7, further comprising:
matching, by the biometric hub, the extracted biometric template to the biometric reference; and
verifying, by the biometric hub, the transformation function for the subject device in response to the matching satisfying a defined threshold.

11. A non-transitory computer-readable storage medium comprising executable instructions, which when executed by at least one processor, cause the at least one processor to:
receive one or more subject images from a first device, wherein a target of one or more reference images and the one or more subject images is consistent;
generate multiple metrics for the one or more reference images and the one or more subject images, the multiple metrics including measurements and/or proportions associated with reference points included in the one or more reference images and the one or more subject images;
generate a transformation function based on the multiple metrics from the one or more reference images and the one or more subject images, wherein the transformation function includes normalization of the one or more subject images to approximate the one or more reference images; and
store the transformation function in a repository.

12. The non-transitory computer-readable storage medium of claim 11, wherein the target of the one or more reference images and the one or more subject images includes a physical feature of a person.

13. The non-transitory computer-readable storage medium of claim 12, wherein the physical feature includes a face or a palm of the person.

14. The non-transitory computer-readable storage medium of claim 11, wherein the executable instructions, when executed by the at least one processor, cause the at least one processor to:
access second reference images from a second device and second subject images from the first device, wherein a second target of the second reference images and the second subject images is consistent;
transform the second reference images;
compare the transformed reference images to the transformed second subject images; and
verify the transformation function in response to the comparison satisfying a defined threshold.

15. The non-transitory computer-readable storage medium of claim 11, wherein the executable instructions, when executed by the at least one processor, cause the at least one processor to:
access a first set of image(s) and a second set of image(s), each of the first and second set of image(s) including a biometric sample of one user;
extract a first biometric from the first set of image(s);
transform the second set of image(s), based on the transformation function;
extract a second biometric from the transformed second set of image(s);
compare the first and second biometrics; and
qualify the first device, in response to the comparison satisfying a defined threshold.

16. The non-transitory computer-readable storage medium of claim 11, wherein the executable instructions, when executed by the at least one processor, cause the at least one processor to provision the transformation function to the first device.
